(19) United States
(12) Patent Application Publication
(10) Pub. No.: US 2026/0142079 A1
(43) Pub. Date: May 21, 2026

(54) Ultracapacitor with a Molecular Sieve Material

(71) Applicant: KYOCERA AVX Components Corporation, Fountain Inn, SC (US)

(72) Inventors: Xiaorong Liu, Simpsonville, SC (US); Bryan Caoile, Simpsonville, SC (US); Ken Brown, Simponsville, SC (US); Michael Maich, Simpsonville, SC (US); Marianne Berolini, Greer, SC (US)

(21) Appl. No.: 19/383,879

(22) Filed: Nov. 10, 2025

Related U.S. Application Data
(60) Provisional application No. 63/720,817, filed on Nov. 15, 2024.

(51) Int. Cl. H01G 2/12; H01G 11/28; H01G 11/52

(52) U.S. Cl. CPC H01G 2/12; H01G 11/28; H01G 11/52

(57) ABSTRACT

An ultracapacitor with a molecular sieve material is provided. The ultracapacitor contains a first electrode that includes a first current collector electrically coupled to a first carbonaceous coating, a second electrode that includes a second current collector electrically coupled to a second carbonaceous coating, a separator positioned between the first electrode and the second electrode, and a nonaqueous electrolyte in ionic contact with the first electrode and the second electrode. The ultracapacitor includes a molecular sieve material including a metal aluminosilicate and a binder. The ultracapacitor also includes a housing within which the first electrode, the second electrode, the separator, the nonaqueous electrolyte, and the molecular sieve material are retained.

### RELATED APPLICATION

The present application is based upon and claims priority to U.S. Provisional Patent Application Ser. No. 63/720,817, having a filing date of Nov. 15, 2024, which is incorporated herein by reference.

### BACKGROUND OF THE INVENTION

Electrochemical energy storage cells are widely used to provide power to electronic, electromechanical, electrochemical, and other useful devices. An electric double layer capacitor (e.g., “ultracapacitor”), for instance, generally employs a pair of polarizable electrodes that contain carbon impregnated with a liquid electrolyte and a separator positioned between the electrodes. However, despite subjecting the electrodes and separator to a drying process, the moisture absorbed in the electrodes and separator may not be completely removed due to the high surface area of the carbon particles and capillary effect. Further, simply increasing the drying temperature to reduce the moisture level may also not be a feasible solution, as the separator may be damaged by the exposure to high temperatures for long periods of time due to oxidation reaction.

It is desired to control moisture contamination to obtain reliable ultracapacitors. For instance, moisture remaining in the electrodes or the separator may react with the liquid electrolyte to form inorganic compounds, such as hydrogen fluoride, which may corrode the electrodes' current collectors. This corrosion may result in electrode delamination and loss of capacitance. Further, trace moisture within the ultracapacitor may attack the solvent and change the conductivity of the electrolyte, leading to an increase in the ultracapacitor's equivalent series resistance (“ESR”). The trace moisture may also be electrolyzed to generate gas, which may ultimately shorten the life of the ultracapacitor. Further, excess moisture within the ultracapacitor may even be able to act as a catalyst to decompose the electrolyte, and the byproducts of this reaction may polymerize and generate even more water within the ultracapacitor.

As such, a need currently exists for an improved ultracapacitor.

### SUMMARY OF THE INVENTION

In accordance with one embodiment of the present invention, an ultracapacitor is disclosed that comprises a first electrode, a second electrode, a separator, a nonaqueous electrolyte, a molecular sieve material, and a housing. The first electrode comprises a first current collector electrically coupled to a first carbonaceous coating and the second electrode comprises a second current collector electrically coupled to a second carbonaceous coating. The separator is positioned between the first electrode and the second electrode, and the nonaqueous electrolyte is in ionic contact with the first electrode and the second electrode. The molecular sieve material comprises a metal aluminosilicate and a binder. The housing retains the first electrode, the second electrode, the separator, the nonaqueous electrolyte, and the molecular sieve material.

In accordance with another embodiment of the present invention, a method for producing a molecular sieve material for use in an ultracapacitor is disclosed. The method comprises grinding pellets comprising a metal aluminosilicate to form a ground metal aluminosilicate, mixing the ground metal aluminosilicate with a binder to form a mixture, and extruding the mixture through a die at a temperature of from about 100° C. to about 200° C. to form the molecular sieve material.

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figure in which:

FIG. 1 is a schematic view of one embodiment of the ultracapacitor of the present invention;

FIG. 2 is a schematic view of another embodiment of the ultracapacitor of the present invention;

FIG. 3 is a schematic view of another embodiment of the ultracapacitor of the present invention;

FIG. 4A and FIG. 4B graphically illustrate the results of Example 1;

FIG. 5A and FIG. 5B graphically illustrate the results of Example 2; and

FIG. 6A and FIG. 6B graphically illustrate the results of Example 3.

Repeat use of reference characters in the present specification and drawing is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only and is not intended as limiting the broader aspects of the present invention, which broader aspects are embodied in the exemplary construction.

Generally speaking, the present invention is directed to an ultracapacitor including a first electrode, a second electrode, a separator, a nonaqueous electrolyte, a molecular sieve material, and a housing. The first electrode includes a first current collector electrically coupled to a first carbonaceous coating and the second electrode includes a second current collector electrically coupled to a second carbonaceous coating. The separator is positioned between the first electrode and the second electrode, and the nonaqueous electrolyte in ionic contact with the first electrode and the second electrode. The molecular sieve material includes a metal aluminosilicate and a binder. The housing retains the first electrode, the second electrode, the separator, the nonaqueous electrolyte, and the molecular sieve material.

Without intending to be limited by theory, the present inventors have found that the use of the molecular sieve materials disclosed herein may provide many benefits to the resulting ultracapacitors, such as better reliability, wider applicability for use in harsh environments, better capacitance retention rate, and lower ESR gain. Further, the molecular sieve materials disclosed herein can easily be added within the housing, and do not require placement on the surface of the electrodes to be effective. Thus, the molecular sieve materials may provide a more cost-effective solution in comparison to having to form different types of ultracapacitors that employ a molecular sieve material on specific surfaces of varying electrodes. Generally, molecular sieve materials are desiccant materials which have high water absorption capacity and thus can be used to prevent and/or remove excess moisture or gas. Additionally, in some embodiments, molecular sieve materials as described herein may have no net charge and thus may remain stable during the life of the ultracapacitor. Molecular sieve materials may, in other embodiments, have small, uniform pores that are capable of selectively absorbing molecules based on their size and shape.

Molecular sieve materials may include a molecular sieve and a binder. In some embodiments, the molecular sieve materials may be formed from a molecular sieve in a powder form. The molecular sieve may include, but is not limited to, metal aluminosilicates, silica gels, activated carbon particles, or other synthetic materials. In certain embodiments, the molecular sieve materials preferably include metal aluminosilicate powders. In some embodiments, the metal aluminosilicates are crystalline metal aluminosilicates and have a three-dimensional interconnecting network of silica and alumni tetrahedra. In certain embodiments, suitable crystalline metal aluminosilicates include, but are not limited to, a kyanite, an andalusite, a sillimanite, a kaolin, a zoisite, a zeolite, a clay mineral, or a combination thereof. In certain embodiments, the metal aluminosilicate is a zeolite. In some embodiments, the metal aluminosilicate has a chemical formula of ⅔K₂O1₃·Na₂₂O·Al₂O₃·2SiO_{2·}·4.5H₂O. In other embodiments, the metal aluminosilicate has a chemical formula of Na₂O·Al₂O₃·2SiO₂·4.5H₂O.

Molecular sieve materials typically have pores of uniform size. For instance, molecular sieve materials may comprise microporous material (pore sizes <2 nm), mesoporous material (pore size 2-50 nm), and microporous material (>50 nm). In some embodiments, the molecular sieve materials disclosed herein have an average pore size of about 3 angstroms to about 10 angstroms (e.g., about 0.3 nm to about 1 nm), such as about 3 angstroms to about 4 angstroms ((e.g. about 0.3 nm to about 0.4 nm).

In one embodiment, the molecular sieve materials have an average pore size of about 2 angstroms or more, such as about 3 angstroms or more, such as about 4 angstroms or more, such as about 5 angstroms or more, such as about 6 angstroms or more, such as about 7 angstroms or more, such as about 8 angstroms or more, and generally less than about 15 angstroms, such as about 12 angstroms or less, such as about 10 angstroms or less, such as about 9 angstroms or less, such as about 8 angstroms or less. In preferred embodiments, the molecular sieve materials may have an average pore size of about 3 angstroms or about 4 angstroms. For instance, in some embodiments, when the metal aluminosilicate has a chemical formula of ⅔K₂O1₃·Na₂₂O·Al₂O₃·2SiO₂·4.5H₂O, the average pore size of the molecular sieve material is about 3 angstrom. In other embodiments, when the metal aluminosilicate has a chemical formula of Na₂O·Al₂O₃·2SiO₂·4.5H₂O, the average pore size of the molecular sieve material is about 4 angstrom.

Without intending to be limited by theory, the particular average pore size of the molecular sieve material may have a correlation with how effective the molecular sieve material is at absorbing water and gas from the ultracapacitor. For instance, the average pore size of the molecular sieve material may be chosen by one of ordinary skill in the art based on the type of substance that is desired to be absorbed, as molecular sieve materials absorb molecules that are smaller than the molecular sieve material's pores.

The average pore sizes of the molecular sieve material as discussed above may be measured using nitrogen adsorption and analyzed by the Barrett-Joyner-Halenda (“BJH”) technique as is well known in the art.

Molecular sieve materials may be used in an ultracapacitor in a variety of different forms. For instance, molecular sieve materials may be in the form of a cylindrical pellet, a bead, or an extrudate, such as a film. For instance, in certain embodiments, the molecular sieve material is a film that is formed when a ground metal aluminosilicate is mixed with a binder to form the molecular sieve material.

A variety of suitable binders can be utilized in the molecular sieve material. For instance, a water-insoluble binder, a water-soluble binder, or a combination thereof may be utilized in the molecular sieve material. In certain embodiments, a water-insoluble organic binder is utilized in the molecular sieve material. For instance, suitable water-insoluble organic binders may include, but are not limited to, a styrene-butadiene copolymer, a polyvinyl acetate homopolymer, a vinyl-acetate ethylene copolymer, a vinyl-acetate acrylic copolymer, an ethylene-vinyl chloride copolymer, an ethylene-vinyl chloride-vinyl acetate terpolymer, an acrylic polyvinyl chloride polymer, an acrylic polymer, a nitrile polymer, a fluoropolymer such as a polytetrafluoroethylene or a polyvinylidene fluoride, a polyolefin, or a combination thereof. In certain embodiments, water-insoluble organic binders are preferred. Preferred water-insoluble organic binders include a polytetrafluoroethylene, a polyethylene, a polypropylene, a styrene-butadiene copolymer, or a combination thereof.

In other embodiments, a water-soluble organic binder is utilized in the molecular sieve material. For instance, suitable water-soluble organic binders include, but are not limited to, a polysaccharide and derivatives thereof. In one particular embodiment, the polysaccharide may be a nonionic cellulosic ether, such as an alkyl cellulose ether (e.g., a methyl cellulose and/or an ethyl cellulose); a hydroxyalkyl cellulose ether (e.g., a hydroxyethyl cellulose, a hydroxypropyl cellulose, a hydroxypropyl hydroxybutyl cellulose, a hydroxyethyl hydroxypropyl cellulose, a hydroxyethyl hydroxybutyl cellulose, a hydroxyethyl hydroxypropyl hydroxybutyl cellulose, etc.); an alkyl hydroxyalkyl cellulose ether (e.g., a methyl hydroxyethyl cellulose, a methyl hydroxypropyl cellulose, an ethyl hydroxyethyl cellulose, an ethyl hydroxypropyl cellulose, a methyl ethyl hydroxyethyl cellulose and a methyl ethyl hydroxypropyl cellulose); a carboxyalkyl cellulose ether (e.g., acarboxymethyl cellulose); or a combination thereof, as well as protonated salts of any of the foregoing, such as a sodium carboxymethyl cellulose and an ammonium carboxymethyl cellulose.

In some embodiments, the binder is present in the molecular sieve material from about 2 wt. % or greater, such as about 3 wt. % or greater, such as about 4 wt. % or greater, such as about 5 wt. % or greater, such as about 6 wt. % or greater, such as about 7 wt. % or greater, such as about 8 wt. % or greater, such as about 9 wt. % or greater, such as about 10 wt. % or greater, such as about 11 wt. % or greater, such as about 12 wt. % or greater, such as about 13 wt. % or greater, such as about 14 wt. % or greater, such as about 15 wt. % or greater, such as about 16 wt. % or greater, such as about 17 wt. % or greater, such as about 18 wt. % or greater, such as about 19 wt. % or greater based on the total weight of the molecular sieve material. In other embodiments, the binder is present in the molecular sieve material from about 50 wt. % or less, such as about 40 wt. % or less, such as about 30 wt. % or less, such as about 25 wt. % or less, such as about 24 wt. % or less, such as about 23 wt. % or less, such as about 22 wt. % or less, such as about 21 wt. % or less, such as about 20 wt. % or less based on the total weight of the molecular sieve material. In certain example embodiments, the binder is present in the molecular sieve material from about 5 wt. % to about 20 wt. % based on the total weight of the molecular sieve material.

In other embodiments, the metal aluminosilicate is present in the molecular sieve material from about 50 wt. % or greater, such as about 55 wt. % or greater, such as about 60 wt. % or greater, such as about 65 wt. % or greater, such as about 70 wt. % or greater, such as about 75 wt. % or greater, such as about 80 wt. % or greater, such as about 85 wt. % or greater based on the total weight of the molecular sieve material. In other embodiments, the metal aluminosilicate is present in the molecular sieve material from about 95 wt. % or less, such as about 92 wt. % or less, such as about 90 wt. % or less, such as about 87 wt. % or less, such as about 85 wt. % or less based on the total weight of the molecular sieve material. In certain example embodiments, the metal aluminosilicate is present in the molecular sieve material from about 80 wt. % to about 95 wt. % based on the total weight of the molecular sieve material.

It should be understood by one of ordinary skill in the art that the molecular sieve material's moisture absorption may depend on many factors, such as the chemical composition of the molecular sieve, the amount of binder mixed with the molecular sieve, and other various chemical and physical properties of the material. For instance, in certain embodiments, the molecular sieve material has a high absorption capacity and can absorb about 2.5% of its weight, such as about 5% of its weight, such as about 7.5% of its weight, such as about 12.5% of its weight, such as about 15% of its weight, such as about 17.5% of its weight, such as about 20% of its weight, and can generally absorb less than about 35% of its weight, such as less than about 32.5% of its weight, such as less than about 30% of its weight, such as less than about 27.5% of its weight, such as less than about 25% of its weight, such as less than about 22.5% of its weight. The absorption capacity of the molecular sieve material as discussed above may be measured using the ASTM D4365 Test Method for Determining the Adsorption Capacity of Desiccants or any other technique as is well known in the art.

The molecular sieve materials of the present disclosure can be formed in a variety of ways, including, but not limited to, extrusion, pelletization, and spray drying. In preferred embodiments, the molecular sieve material is formed through extrusion. Without intending to be limited by theory, the present inventors have found that forming the molecular sieve material through extrusion is particularly advantageous, as extrusion allows the metal aluminosilicate to be mixed with a binder and manipulated to form a molecular sieve material of various different configurations or shapes. Further, the present inventors have found that by forming the molecular sieve material through extrusion, the moisture absorption of the molecular sieve material may be increased.

For instance, in certain embodiments, the molecular sieve material is formed by grinding pellets comprising a metal aluminosilicate to form a ground metal aluminosilicate and then mixing the ground metal aluminosilicate with a binder to form a mixture. The mixture is subjected to mechanical extrusion to form a molecular sieve material that is in the form of a film. The mixture is extruded through a die at an elevated temperature. In some embodiments, the elevated temperate can be greater than about 50° C., such as greater than about 60° C., such as greater than about 70° C., such as greater than about 80° C., such as greater than about 90° C., such as greater than about 100° C., such as greater than about 110° C., such as greater than about 120° C., such as greater than about 130° C., such as greater than about 140° C., such as greater than about 150° C., such as greater than about 160° C., such as greater than about 170° C., and generally less than about 250° C., such as less than about 240° C., such as less than about 230° C., such as less than about 220° C., such as less than about 210° C., such as less than about 200° C., such as less than about 190° C., such as less than about 180° C. In other embodiments, the elevated temperature at which the mixture is extruded through a die to form the molecular sieve material is from about 100° C. to about 200° C. However, it should be understood by one of ordinary skill in the art that the temperature can be manipulated to form varying physical characteristics of the resulting molecular sieve material.

The resulting molecular sieve materials may then be tailored to form various shapes depending on the size and type of housing that retains the ultracapacitor and the desired placement of the molecular sieve materials. For instance, the molecular sieve materials can be tailored to have any known shape, such as, but not limited to, a circular shape or a rectangular shape. The molecular sieve materials can also be placed anywhere within the housing to remove excess moisture. The present inventors have found that the molecular sieve material is effective even when placed on the top of the housing, the bottom of the housing, the side of the housing, or a combination thereof. For instance, molecular sieve materials with a circular or “disc” like shape can be placed on the bottom or top of a housing and can even be placed to sit sideways inside of the housing. In other embodiments, the molecular sieve materials can be located on the top or bottom of the electrode/separator pack. Without intending to be limited by theory, the present inventors have found that placing the molecular sieve material on top or bottom of the electrode/separator pack is particularly useful when the housing is a flexible package.

One or more molecular sieve materials may be placed inside the housing. For instance, one or more molecular sieve materials may be utilized, such as about two or more molecular sieve materials, such as about three or more molecular sieve materials, and generally less than about 5 molecular sieve materials, such as about four molecular sieve materials or less.

Notably, without intending to be limited by theory, the present inventors have found that the molecular sieve materials are effective at removing moisture from the ultracapacitor even when the molecular sieve material has no direct contact between the electrode surface and the separator. Thus, in some embodiments, the molecular sieve material is not placed on a surface of the first electrode or the second electrode. When the molecular sieve material is placed on the electrode surface between the electrode and the separator, the ultracapacitor may have a significant increase in ESR. Whereas the molecular sieve materials as described herein may be placed anywhere within the housing of the ultracapacitor to effectively remove trace moisture without increasing the ESR of the ultracapacitor. Thus, the present inventors have found that selective control over the placement of the molecular sieve material may result in ultracapacitors that have a longer life, better reliability, and wider applications particularly in harsh environments, such as environments with high temperature and/or high humidity.

As indicated, the ultracapacitor includes an electrolyte. The electrolyte is generally nonaqueous in nature and thus contains at least one nonaqueous solvent. To help extend the operating temperature range of the ultracapacitor, the nonaqueous solvent has a relatively high boiling temperature, such as about 150° C. or more, in some embodiments about 200° C. or more, and in some embodiments, from about 220° C. to about 300° C. Particularly suitable high boiling point solvents may include, for instance, cyclic carbonate solvents, such as ethylene carbonate, propylene carbonate, butylene carbonate, vinylene carbonate, etc. Propylene carbonate is particularly suitable due to its high electric conductivity and decomposition voltage, as well as its ability to be used over a wide range of temperatures. Of course, other nonaqueous solvents may also be employed, either alone or in combination with a cyclic carbonate solvent. Examples of such solvents may include, for instance, open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, etc.), amides (e.g., N,N-dimethylformamide, N, N-diethylacetamide, N-methylpyrrolidinone), alkanes (e.g., nitromethane, nitroethane, etc.), sulfur compounds (e.g., sulfolane, dimethyl sulfoxide, dimethyl sulfone etc.); and so forth. In preferred embodiments, the solvents may comprise sulfolane, dimethyl sulfone, acetonitrile, or combinations thereof.

The electrolyte also contains at least one ionic liquid, which is dissolved in the nonaqueous solvent. Typically, the ionic liquid is present at a relatively high concentration. For example, the ionic liquid may be present in an amount of about 1.0 mole per liter (M) of the electrolyte or more, in some embodiments about 1.2 M or more, in some embodiments about 1.3 M or more, and in some embodiments about 1.4 or more. In other embodiments, the ionic liquid may be present in an amount of about 3.0 M or less, in some embodiments about 2.5 M or less, and in some embodiments about 2.0 M or less.

The ionic liquid is generally a salt having a relatively low melting temperature, such as about 400° C. or less, in some embodiments about 350° C. or less, in some embodiments from about 1° C. to about 100° C., and in some embodiments, from about 5° C. to about 50° C. The salt contains a cationic species and counterion. The cationic species contains a compound having at least one heteroatom (e.g., nitrogen or phosphorous) as a “cationic center.” Examples of such heteroatomic compounds include, for instance, unsubstituted or substituted organoquaternary ammonium compounds, such as ammonium (e.g., trimethylammonium, tetraethylammonium, etc.), pyridinium, pyridazinium, pyramidinium, pyrazinium, imidazolium, pyrazolium, oxazolium, triazolium, thiazolium, quinolinium, piperidinium, pyrrolidinium, quaternary ammonium spiro compounds in which two or more rings are connected together by a spiro atom (e.g., carbon, heteroatom, etc.), quaternary ammonium fused ring structures (e.g., quinolinium, isoquinolinium, etc.), and so forth. In one particular embodiment, for example, the cationic species may be an N-spirobicyclic compound, such as symmetrical or asymmetrical N-spirobicyclic compounds having cyclic rings. One example of such a compound has the following structure:

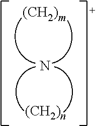

wherein m and n are independently a number from 3 to 7, and in some embodiments, from 4 to 5 (e.g., pyrrolidinium or piperidinium).

Particularly suitable cations have a median ionic radius size of greater than about 0.10 nanometers, such as greater than about 0.11 nanometers, such as greater than about 0.12 nanometers, such as greater than about 0.13 nanometers, such as greater than about 0.14 nanometers, such as greater than 0.15 nanometers, such as greater than 0.16 nanometers. In other embodiments particularly suitable cations have a median ionic radius size of less than about 1.0 nanometers, such as less than about 0.5 nanometers, such as less than about 0.3 nanometers, such as less than about 0.2 nanometers, such as less than about 0.19 nanometers, such as less than about 0.18 nanometers, such as less than about 0.17 nanometers. In certain embodiments, the ionic radius may be the solvated ionic radius if the ions are in liquid solutions, such that the median ionic radius takes into account the radius of the ion and the solvation shell. In preferred embodiments, suitable cations include tetraethylammonium, triethylmethylammonium, spiro-(1,1′)-bipyrrolidinium, N,N′-dimethylpiperazine, and 1,1-dimethylpyrrolidinium.

Suitable counterions for the cationic species may likewise include halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing.

Particularly suitable counterions have a median ionic radius size of greater than about 0.03 nanometers, such as greater than about 0.04 nanometers, such as greater than about 0.05 nanometers, such as greater than about 0.06 nanometers, such as greater than about 0.07 nanometers, such as greater than about 0.08 nanometers, such as greater than about 0.09 nanometers, such as greater than about 0.10 nanometers. In other embodiments, particularly suitable counterions have a median ionic radius size of less than about 1.0 nanometers, such as less than about 0.5 nanometers, such as less than about 0.2 nanometers, such as less than about 0.15 nanometers, such as less than about 0.14 nanometers, such as less than about 0.13 nanometers, and such as less than about 0.125 nanometers. In certain embodiments, the ionic radius may be the solvated ionic radius if the ions are in liquid solutions, such that the median ionic radius takes into account the radius of the ion and the solvation shell. In preferred embodiments, suitable counterions include tetrafluoroborate and bis(oxolato)borate.

Several examples of suitable ionic liquids may include, for instance, spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, and/or tetraethylammonium hexafluorophosphate.

Suitable ionic liquid displays a ratio of the median ionic radius size of the cationic species to the median ionic radius size of the counterion of greater than about 1.0, such as greater than about 1.5, such as greater than about 2.0, such as greater than about 2.5, such as greater than about 3.0, such as greater than about 3.5, such as greater than about 4.0, such as greater than about 4.5, such as greater than about 5.0. In other embodiments, the ionic liquids display a ratio of the median ionic radius size of the cationic species to the median ionic radius of the counterion of less than about 10.0, such as less than about 9.0, such as less than about 8.0, such as less than about 7.0. In preferred embodiments, the ionic liquid displays a ratio of the median ionic radius size of the cationic species to the median ionic radius size of the counterion of greater than about 3.0, such as greater than about 3.5, such as greater than about 4.0.

The ultracapacitor also includes a first electrode and a second electrode. The first electrode comprises a first current collector electrically coupled to a first carbonaceous coating, and the second electrode comprises a second current collector electrically coupled to a second carbonaceous coating. In some embodiments, the first and second electrodes may also contain binders.

In certain embodiments, however, the electrodes need not contain a substantial amount of binders conventionally employed in ultracapacitor electrodes. That is, binders may be present in an amount of about 60 parts or less, in some embodiments 40 parts or less, and in some embodiments, from about 1 to about 25 parts per 100 parts of carbon in the first and/or second carbonaceous coatings. Binders may, for example, constitute about 15 wt. % or less, in some embodiments about 10 wt. % or less, and in some embodiments, from about 0.5 wt. % to about 5 wt. % of the total weight of a carbonaceous coating.

Nevertheless, when employed, any of a variety of suitable binders can be used in the electrodes. For instance, in some embodiments, a water-insoluble organic binder, a water-soluble organic binder, or a combination thereof may be utilized in the electrodes. In some embodiments, a water-insoluble organic binder may be employed, such as a styrene-butadiene copolymer, a polyvinyl acetate homopolymer, a vinyl-acetate ethylene copolymer, a vinyl-acetate acrylic copolymer, an ethylene-vinyl chloride copolymer, an ethylene-vinyl chloride-vinyl acetate terpolymer, an acrylic polyvinyl chloride polymer, an acrylic polymer, a nitrile polymer, a fluoropolymer such as polytetrafluoroethylene or polyvinylidene fluoride, a polyolefins, or a combination thereof.

In other embodiments, a water-soluble organic binder may be employed, such as a polysaccharide and derivatives thereof. In one particular embodiment, the polysaccharide may be a nonionic cellulosic ether, such as an alkyl cellulose ether (e.g., a methyl cellulose and an ethyl cellulose); a hydroxyalkyl cellulose ether (e.g., a hydroxyethyl cellulose, a hydroxypropyl cellulose, a hydroxypropyl hydroxybutyl cellulose, a hydroxyethyl hydroxypropyl cellulose, a hydroxyethyl a hydroxybutyl cellulose, a hydroxyethyl hydroxypropyl hydroxybutyl cellulose, etc.); an alkyl hydroxyalkyl cellulose ether (e.g., a methyl hydroxyethyl cellulose, a methyl hydroxypropyl cellulose, an ethyl hydroxyethyl cellulose, an ethyl hydroxypropyl cellulose, a methyl ethyl hydroxyethyl cellulose and a methyl ethyl hydroxypropyl cellulose); a carboxyalkyl cellulose ether (e.g., a carboxymethyl cellulose); and so forth, as well as protonated salts of any of the foregoing, such as a sodium carboxymethyl cellulose and an ammonium carboxymethyl cellulose.

As discussed above, the ultracapacitor of the present invention contains first and second carbonaceous coatings that are electrically coupled to the first and second current collectors, respectively. While the first and second carbonaceous coatings may be formed from the same or different types of materials and may contain one or multiple layers, each of the carbonaceous coatings generally contains at least one layer that includes activated carbon particles, binders, and/or carbon black. In certain embodiments, for instance, the carbonaceous coating may be directly positioned over the current collector. Examples of suitable activated carbon particles used in the carbonaceous coatings may include, for instance, potassium hydroxide (KOH) activated carbon, water steam activated carbon, coconut shell-based activated carbon, petroleum coke-based activated carbon, pitch-based activated carbon, polyvinylidene chloride-based activated carbon, phenolic resin-based activated carbon, polyacrylonitrile-based activated carbon, and activated carbon from natural sources such as coal, charcoal or other natural organic sources. In some embodiments, the first and second carbonaceous coating comprise different materials. For instance, in some embodiments the first carbonaceous coating comprises KOH activated carbon, and the second carbonaceous coating comprises water steam activated carbon.

In certain embodiments, it may be desired to selectively control certain aspects of the activated carbon particles, such as their particle size distribution, surface area, and pore size distribution to help reduce ion mobility for certain types of electrolytes after being subjected to one or more charge-discharge cycles. Therefore, in certain embodiments, the first carbonaceous coating and the second carbonaceous coating may comprise the same material. Even when the first carbonaceous coating and the second carbonaceous coating comprise the same material(s), they may have different porosity profiles. However, they may also have the same porosity or particle profiles.

For instance, in some embodiments, the first and second plurality of pores of the first and second carbonaceous coatings, respectively, have a pore volume with a median diameter size of less than about 2 nanometers in size (i.e., “micropores”) of about 50 vol. % or less, such as 45 vol. % or less, such as 40 vol. % or less, such as 35 vol. % or less, such as about 30 vol. % or less, such as 25 vol. % or less, such as 20 vol. % or less. In other embodiments, the pore volume with a median diameter size of less than about 2 nanometers is about 0.1 vol. % or more, such as about 0.5 vol. % or more, such as about 1 vol. % or more, such as about 5 vol. % or more, such as about 10 vol. % or more, such as about 15 vol. % or more. In some embodiments, the pore volume with a median diameter size of less than about 2 nanometers is from 0.1 vol. % to 15 vol. % of the pore volume.

The amount of pores between about 2 nanometers and about 50 nanometers in size (i.e., “mesopores”) may likewise be from about 20 vol. % to about 100 vol. %, in some embodiments from about 25 vol. % to about 75 vol. %, and in some embodiments, from about 35 vol. % to about 65 vol. % of the second pore volume. For instance, in some embodiments, the amount of pores between about 2 nanometers to about 50 nanometers in size may be about 20 vol. % or more, such as about 25 vol % or more, such as about 30 vol. % or more, such as about 35 vol. % or more, such as about 40 vol. % or more, such as about 50 vol. % or more, such as about 60 vol. % or more, such as about 70 vol. % or more. In other embodiments, the amount of pores between about 2 nanometers to about 50 nanometers in size may be about 100 vol. % or less, such as about 90 vol. % or less, such as about 80 vol. % or less, such as about 75 vol. % or less, such as about 70 vol. % or less, such as about 65 vol. % or less, such as about 60 vol. % or less, such as about 55 vol. % or less, such as about 50 vol. % or less, such as about 45 vol. % or less.

The amount of pores greater than about 50 nanometers in size (i.e., “macropores”) may be from about 10 vol. % to about 100 vol. %, in some embodiments from about 5 vol. % to about 75 vol. %, and in some embodiments, from about 10 vol. % to about 50 vol. % of the pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more, such as about 30 vol. % or more, such as about 40 vol. % or more, such as about 45 vol. % or more, such as about 50 vol. % or more, such as about 55 vol. % or more, such as about 60 vol. % or more. In other embodiments, the amount of pores greater than about 50 nanometers in size may be about 100 vol. % or less, such as about 90 vol. % or less, such as about 80 vol. % or less, such as about 70 vol. % or less, such as about 60 vol. % or less, such as about 50 vol. % or less, such as about 45 vol. % or less, such as about 40 vol. % or less, such as about 35 vol. % or less, such as about 30 vol. % or less.

In other embodiments, the first and second plurality of pores of the first and second carbonaceous coatings, respectively, have a total pore volume, the total pore volume comprising about 50 vol. % or more of pores having a median pore diameter size of about 2 nanometers (i.e., “micropores”) or less, such as about 55 vol. % or more of pores having a median pore diameter size of about 2 nanometers or less, such as about 60 vol. % or more of pores having a median pore diameter size of about 2 nanometers or less, such as about 65 vol. % or more of pores having a median pore diameter size of about 2 nanometers or less, such as about 70 vol. % or more of pores having a median pore diameter size of about 2 nanometers or less, such as about 75 vol. % or more of pores having a median pore diameter size of about 2 nanometers or less. In other embodiments, the total pore volume comprises about 100 vol. % or less of pores having a median pore diameter size of about 2 nanometers or less, such as about 95 vol. % or less of pores having a median pore diameter size of about 2 nanometers or less, such as about 90 vol. % or less of pores having a median pore diameter size of about 2 nanometers or less, such as about 85 vol. % or less of pores having a median pore diameter size of about 2 nanometers or less.

The amount of pores between about 2 nanometers and about 50 nanometers in size (i.e., “mesopores”) may likewise be from about 20 vol. % to about 50 vol. %, in some embodiments from about 25 vol. % to about 45 vol. %, and in some embodiments, from about 35 vol. % to about 40 vol. % of the first pore volume. For instance, in some embodiments, the amount of pores between about 2 nanometers to about 50 nanometers in size may be about 5 vol. % or more, such as about 10 vol. % or more, such as about 15 vol. % or more, such as about 20 vol. % or more, such as about 25 vol % or more, such as about 30 vol. % or more, such as about 35 vol. % or more, such as about 40 vol. % or more. In other embodiments, the amount of pores between about 2 nanometers to about 50 nanometers in size may be about 60 vol. % or less, such as about 55 vol. % or less, such as about 50 vol. % or less, such as about 45 vol. % or less.

The amount of pores greater than about 50 nanometers in size (i.e., “macropores”) may be from about 1 vol. % to about 50 vol. %, in some embodiments from about 5 vol. % to about 40 vol. %, and in some embodiments, from about 10 vol. % to about 35 vol. % of the first pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more. In other embodiments, the amount of pores greater than about 50 nanometers in size may be about 50 vol. % or less, such as about 45 vol. % or less, such as about 40 vol. % or less, such as about 35 vol. % or less, such as about 30 vol. % or less.

Without intending to be limited by theory, the present inventors have also discovered that the ultracapacitor can demonstrate enhanced results in some embodiments when the first carbonaceous coating and the second carbonaceous coating comprise different materials, resulting in the second carbonaceous coating comprising a second total pore volume with a different size distribution and porosity profile than the first total pore volume of the first carbonaceous coating.

In certain embodiments, for instance, the first plurality of pores of the first carbonaceous coating has a first total pore volume, the first total pore volume comprising about 50 vol. % or more of pores having a median pore diameter size of about 2 nanometers (i.e., “micropores”) or less, such as about 55 vol. % or more of pores having a median pore diameter size of about 2 nanometers or less, such as about 60 vol. % or more of pores having a median pore diameter size of about 2 nanometers or less, such as about 65 vol. % or more of pores having a median pore diameter size of about 2 nanometers or less, such as about 70 vol. % or more of pores having a median pore diameter size of about 2 nanometers or less, such as about 75 vol. % or more of pores having a median pore diameter size of about 2 nanometers or less. In other embodiments, the first total pore volume comprises about 100 vol. % or less of pores having a median pore diameter size of about 2 nanometers or less, such as about 95 vol. % or less of pores having a median pore diameter size of about 2 nanometers or less, such as about 90 vol. % or less of pores having a median pore diameter size of about 2 nanometers or less, such as about 85 vol. % or less of pores having a median pore diameter size of about 2 nanometers or less.

The amount of pores between about 2 nanometers and about 50 nanometers in size (i.e., “mesopores”) may likewise be from about 20 vol. % to about 50 vol. %, in some embodiments from about 25 vol. % to about 45 vol. %, and in some embodiments, from about 35 vol. % to about 40 vol. % of the first pore volume. For instance, in some embodiments, the amount of pores between about 2 nanometers to about 50 nanometers in size may be about 5 vol. % or more, such as about 10 vol. % or more, such as about 15 vol. % or more, such as about 20 vol. % or more, such as about 25 vol % or more, such as about 30 vol. % or more, such as about 35 vol. % or more, such as about 40 vol. % or more. In other embodiments, the amount of pores between about 2 nanometers to about 50 nanometers in size may be about 60 vol. % or less, such as about 55 vol. % or less, such as about 50 vol. % or less, such as about 45 vol. % or less.

The amount of pores greater than about 50 nanometers in size (i.e., “macropores”) may be from about 1 vol. % to about 50 vol. %, in some embodiments from about 5 vol. % to about 40 vol. %, and in some embodiments, from about 10 vol. % to about 35 vol. % of the first pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more. In other embodiments, the amount of pores greater than about 50 nanometers in size may be about 50 vol. % or less, such as about 45 vol. % or less, such as about 40 vol. % or less, such as about 35 vol. % or less, such as about 30 vol. % or less.

The total pore volume of the carbon particles in the first plurality of pores may be in the range of from about 0.2 cm³/g to about 2.0 cm³/g, and in some embodiments, from about 0.4 cm³/g to about 1.0 cm³/g. In other embodiments, the total pore volume of the carbon particles in the first plurality of pores is about 0.97 cm³/g. In certain embodiments, the single point adsorption total pore volume of pores less than about 3,650 Å at about p/p°=1.0 is about 0.800 m³/g or more, such as about 0.840 m³/g or more, such as about 0.880 m³/g or more, such as about 0.900 m³/g or more, and in some embodiments, such as about 0.950 m³/g or less, such as about 0.930 m³/g or less, such as about 0.920 m³/g or less.

The BET surface area of the activated carbon particles in the first carbonaceous coating may also range from about 900 m²/g to about 3,000 m²/g, in some embodiments from about 1,000 m²/g to about 2,500 m²/g, and in some embodiments, from about 1,100 m²/g to about 1,800 m²/g. In certain embodiments, the BET surface area of the activated carbon particles may be about 1,300 m²/g or greater, such as 1,400 m²/g, such as 1,500 m²/g or greater. In other embodiments, the BET surface area of the activated carbon particles may be about 1,750 m²/g or less, such as 1,700 m²/g or less, such as about 1,600 m²/g or less. In other embodiments, the activated carbon in the first carbonaceous coating has a BET surface area of about 1630 m²/g to about 1720 m²/g.

In certain embodiments, the first plurality of pores of the first carbonaceous coating have a median pore diameter size, the counterion of the ionic liquid has a median ionic radius size, and the ultracapacitor demonstrates a ratio of the median pore diameter size of the first plurality of pores to the median ionic radius size of the counterion of from about 0.5 or greater, such as from about 0.6 or greater, such as from about 0.7 or greater, such as from about 0.8 or greater, such as from about 0.9 or greater, and such as from about 1.0 or greater. In other embodiments, the ratio of the median pore diameter size of the first plurality of pores to the median ionic radius size of the counterion is from about 1.5 or less, such as from about 1.4 or less, such as from about 1.3 or less, such as from about 1.2 or less, and such as from about 1.1 or less. In preferred embodiments, the ratio of the median pore diameter size of the first plurality of pores to the median ionic radius size of the counterion is about 0.95 to about 1.05. For instance, in certain embodiments, the ratio of the median pore diameter size of the first plurality of pores to the median ionic radius size of the counterion is about 0.95 or greater, such as about 0.96 or greater, such as about 0.97 or greater, such as about 0.98 or greater, such as about 0.99 or greater, such as about 1.0 or greater, In other embodiments, the ratio of the median pore diameter size of the first plurality of pores to the median ionic radius size of the counterion is about 1.05 or less, such as about 1.04 or less, such as about 1.03 or less, such as about 1.02 or less, such as about 1.01 or less.

In some embodiments, the second carbonaceous coating may comprise a second plurality of pores having a second pore volume with a median diameter size of less than about 2 nanometers in size (i.e., “micropores”) of about 50 vol. % or less, such as 45 vol. % or less, such as 40 vol. % or less, such as 35 vol. % or less, such as about 30 vol. % or less, such as 25 vol. % or less, such as 20 vol. % or less. In other embodiments, the second plurality of pores has a second pore volume with a median diameter size of less than about 2 nanometers of about 0.1 vol. % or more, such as about 0.5 vol. % or more, such as about 1 vol. % or more, such as about 5 vol. % or more, such as about 10 vol. % or more, such as about 15 vol. % or more. In some embodiments, the second plurality of pores has a second pore volume with a median diameter size of less than about 2 nanometers of from 0.1 vol. % to 15 vol. % of the second pore volume.

The amount of pores between about 2 nanometers and about 50 nanometers in size (i.e., “mesopores”) may likewise be from about 20 vol. % to about 100 vol. %, in some embodiments from about 25 vol. % to about 75 vol. %, and in some embodiments, from about 35 vol. % to about 65 vol. % of the second pore volume. For instance, in some embodiments, the amount of pores between about 2 nanometers to about 50 nanometers in size may be about 20 vol. % or more, such as about 25 vol % or more, such as about 30 vol. % or more, such as about 35 vol. % or more, such as about 40 vol. % or more, such as about 50 vol. % or more, such as about 60 vol. % or more, such as about 70 vol. % or more. In other embodiments, the amount of pores between about 2 nanometers to about 50 nanometers in size may be about 100 vol. % or less, such as about 90 vol. % or less, such as about 80 vol. % or less, such as about 75 vol. % or less, such as about 70 vol. % or less, such as about 65 vol. % or less, such as about 60 vol. % or less, such as about 55 vol. % or less, such as about 50 vol. % or less, such as about 45 vol. % or less.

The amount of pores greater than about 50 nanometers in size (i.e., “macropores”) may be from about 10 vol. % to about 100 vol. %, in some embodiments from about 5 vol. % to about 75 vol. %, and in some embodiments, from about 10 vol. % to about 50 vol. % of the second pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more, such as about 30 vol. % or more, such as about 40 vol. % or more, such as about 45 vol. % or more, such as about 50 vol. % or more, such as about 55 vol. % or more, such as about 60 vol. % or more. In other embodiments, the amount of pores greater than about 50 nanometers in size may be about 100 vol. % or less, such as about 90 vol. % or less, such as about 80 vol. % or less, such as about 70 vol. % or less, such as about 60 vol. % or less, such as about 50 vol. % or less, such as about 45 vol. % or less, such as about 40 vol. % or less, such as about 35 vol. % or less, such as about 30 vol. % or less.

The second total pore volume of the carbon particles in the second plurality of pores may be in the range of from about 0.2 cm³/g to about 2.0 cm³/g, and in some embodiments, from about 0.4 cm³/g to about 1.0 cm³/g. In other embodiments, the single point adsorption total pore volume of pores less than about 3,650 Å at about p/p°=1.0 in the second carbonaceous coating is about 0.770 m³/g or greater, such as about 0.780 m³/g or greater, such as about 0.790 m³/g or greater, and such as about 0.810 m³/g or less, such as about 0.800 m³/g or less. In certain embodiments, the single point adsorption total pore volume is about 0.786 m³/g.

The second carbonaceous coating comprises activated carbon particles with a BET surface area of about 1,300 m²/g or greater, such as about 1,350 m²/g or greater, such as about 1,360 m²/g or greater, such as about 1,370 m²/g or greater. In other embodiments, the second carbonaceous coating comprises activated carbon particles with a BET surface area of about 1,450 m²/g or less, such as about 1,425 m²/g or less, such as about 1,400 m²/g or less, such as about 1,380 m²/g or less. In preferred embodiments, the second carbonaceous coating comprises activated carbon particles with a BET surface area of about 1,360 m²/g to about 1,370 m²/g.

In certain embodiments, the second plurality of pores has a median pore diameter size and the ratio of the median pore diameter size of the second plurality of pores to the median ionic radius size of the counterion is from about 1.5 to about 10.0. For instance, the ratio of the median pore diameter size of the second plurality of pores to the median ionic radius size of the counterion is from about 1.5 or more, such as about 2.0 or more, such as about 2.5 or more, such as about 3.0 or more, such as about 3.5 or more, such as about 4.0 or more, In other embodiments, the ratio of the median pore diameter size of the second plurality of pores to the median ionic radius size of the counterion is from about 10 or less, such as about 9 or less, such as about 8 or less, such as about 7 or less, such as about 6 or less, such as about 5.0 or less. In certain embodiments, the ratio of the median pore diameter size of the second plurality of pores to the median ionic radius size of the counterion is from about 1.5 to about 5.0.

The pore sizes and total pore volume for both the first carbonaceous coating and the second carbonaceous coating as discussed above may be measured using nitrogen adsorption and analyzed by the Barrett-Joyner-Halenda (“BJH”) technique as is well known in the art.

If desired, other materials may also be employed within an activated carbon layer of the first and/or second carbonaceous coatings and/or within other layers of the first and/or second carbonaceous coatings. For example, in certain embodiments, a conductivity promoter may be employed to further increase electrical conductivity. Exemplary conductivity promoters may include, for instance, carbon black, graphite (natural or artificial), graphite, carbon nanotubes, nanowires or nanotubes, metal fibers, graphenes, etc., as well as mixtures thereof. Carbon black is particularly suitable. When employed, conductivity promoters typically constitute about 60 parts or less, in some embodiments 40 parts or less, and in some embodiments, from about 1 to about 25 parts per 100 parts of the activated carbon particles in a carbonaceous coating. Conductivity promotes may, for example, constitute about 15 wt. % or less, in some embodiments about 10 wt. % or less, and in some embodiments, from about 0.5 wt. % to about 5 wt. % of the total weight of a carbonaceous coating. Activated carbon particles likewise typically constitute 85 wt. % or more, in some embodiments about 90 wt. % or more, and in some embodiments, from about 95 wt. % to about 99.5 wt. % of a carbonaceous coating.

The particular manner in which a carbonaceous coating is applied to a current collector may vary as is well known to those skilled in the art, such as printing (e.g., rotogravure), spraying, slot-die coating, drop-coating, dip-coating, etc. Regardless of the manner in which it is applied, the resulting electrode is typically dried to remove moisture from the coating, such as at a temperature of about 100° C. or more, in some embodiments about 200° C. or more. The electrode may also be compressed (e.g., calendered) to optimize the volumetric efficiency of the ultracapacitor. After any optional compression, the thickness of each carbonaceous coating may generally vary based on the desired electrical performance and operating range of the ultracapacitor. Typically, however, the thickness of a coating is about 20 micrometers or greater, about 30 micrometers or greater, and such as about 40 micrometers or greater. In other embodiments, the thickness of a coating is about 200 micrometers or less, such as about 175 micrometers or less, such as about 170 micrometers or less, such as from about 150 micrometers or less, such as from about 100 micrometers or less. In certain embodiments, the thickness of a coating ranges from about 175 to about 200 micrometers. For instance, the thickness of the first carbonaceous coating may be about 200 micrometers and the thickness of the second carbonaceous coating may be about 175 micrometers. Coatings may be present on one or both sides of a current collector.

In certain embodiments, the first carbonaceous coating of the first electrode has a first thickness, the second carbonaceous coating of the second electrode has a second thickness, and the ultracapacitor has a ratio of the first thickness to the second thickness of from about 1.0 to about 2.5, such as from about 1.1 to about 2.0. For instance, in certain embodiments, the ratio of the first thickness to the second thickness is about 1.0 or greater, such as about 1.1 or greater, such as about 1.2 or greater, such as about 1.25 or greater, such as about 1.3 or greater, such as about 1.35 or greater, such as about 1.4 or greater, such as about 1.5 or greater, such as about 1.6 or greater. In other embodiments, the ratio of the first thickness to the second thickness is about 2.5 or less, such as about 2.0 or less, such as about 1.9 or less, such as about 1.8 or less, such as about 1.7 or less. In some embodiments, the ratio of the first thickness to the second thickness is about 1.25 to about 1.35. In preferred embodiments, the ratio of the first thickness to the second thickness is about 1.3.

As indicated above, the first electrode contains a first current collector and the second electrode contains a second current collector that are electrically coupled to the first carbonaceous coating and the second carbonaceous coating, respectively. It should be understood that additional current collectors may also be employed if desired, particularly if the ultracapacitor includes multiple energy storage cells. The current collectors may be formed from the same or different materials. Regardless, each collector is typically formed from a substrate that includes a conductive metal, such as aluminum, stainless steel, nickel, silver, palladium, etc., as well as alloys thereof. Aluminum and aluminum alloys are particularly suitable for use in the present invention. The substrate may be in the form of a foil, sheet, plate, mesh, etc. The substrate may also have a relatively small thickness, such as about 200 micrometers or less, in some embodiments from about 1 to about 100 micrometers, in some embodiments from about 5 to about 80 micrometers, and in some embodiments, from about 10 to about 50 micrometers. Although by no means required, the surface of the substrate may be optionally roughened, such as by washing, etching, blasting, etc.

In certain embodiments, at least one of the first and second current collectors, and preferably both, also contain a plurality of fiber-like whiskers that project outwardly from the substrate. Without intending to be limited by theory, it is believed that these whiskers can effectively increase the surface area of the current collector and also improve the adhesion of the current collector to the corresponding electrode. This can allow for the use of a relatively low binder content in the first electrode and/or second electrode, which can improve charge transfer and reduce interfacial resistance and consequently result in very low ESR values. The whiskers are typically formed from a material that contains carbon and/or a reaction product of carbon and the conductive metal. In one embodiment, for example, the material may contain a carbide of the conductive metal, such as aluminum carbide (Al₄C₃).

The manner in which such whiskers are formed on the substrate may vary as desired. In one embodiment, for instance, the conductive metal of the substrate reacts with a hydrocarbon compound. Examples of such hydrocarbon compounds may include, for instance, paraffin hydrocarbon compounds, such as methane, ethane, propane, n-butane, isobutane, pentane, etc.; olefin hydrocarbon compounds, such as ethylene, propylene, butene, butadiene, etc.; acetylene hydrocarbon compounds, such as acetylene; as well as derivatives or combinations of any of the foregoing. It is generally desired that the hydrocarbon compounds are in a gaseous form during the reaction. Thus, it may be desired to employ hydrocarbon compounds, such as methane, ethane, and propane, which are in a gaseous form when heated. Although not necessarily required, the hydrocarbon compounds are typically employed in a range of from about 0.1 parts to about 50 parts by weight, and in some embodiments, from about 0.5 parts by weight to about 30 parts by weight, based on 100 parts by weight of the substrate. To initiate the reaction with the hydrocarbon and conductive metal, the substrate is generally heated in an atmosphere that is at a temperature of about 300° C. or more, in some embodiments about 400° C. or more, and in some embodiments, from about 500° C. to about 650° C. The time of heating depends on the exact temperature selected but typically ranges from about 1 hour to about 100 hours. The atmosphere typically contains a relatively low amount of oxygen to minimize the formation of a dielectric film on the surface of the substrate. For example, the oxygen content of the atmosphere may be about 1% by volume or less.

In some embodiments, the positive electrode is thicker than the negative electrode. Without intending to be limited by theory, the present inventors have discovered that, when the positive electrode is thicker than the negative electrode, the resulting ultracapacitor may demonstrate higher voltage retention rates and higher specific capacitance. For instance, the present inventors have found that the positive electrode may have a greater impact on the voltage retention rate of the ultracapacitor than the negative electrode, because the positive electrode has a high ion migration capability. According to Ohm's law, the voltage retention rate of the ultracapacitor is inverse to the cell voltage or electrode potential. Therefore, the higher the voltage, the lower the voltage retention rate, meaning the ultracapacitor is more likely to “self-discharge” and therefore not be a reliable energy source. Resultingly, the present inventors have found that by selectively controlling the thickness of the first electrode and the first carbonaceous coating, the resulting ultracapacitor is better suited for use in an energy reserve system.

For instance, the present inventors have found that the electrode thickness balance can be manipulated based on the specific electrolyte utilized based on these charge equations:

$${Q}_{+} = {{C}_{+}}^{*} {ΔV}_{+}$$

wherein Q₊ is the charge of the first electrode, C₊ is the capacitance of the first electrode, and ΔV₊ is the change in voltage of the first electrode.
and

$${Q}_{-} = {{C}_{-}}^{⋆} Δ {V}_{-}$$

wherein Q₋ is the charge of the second electrode, C₋ is the capacitance of the second electrode, and ΔV₋ is change in voltage of the second electrode.

Due to the law of electroneutrality, therefore Q+=C+*ΔV₊=Q₋=C₋*ΔV—

Thus, if the first electrode is thicker than the second electrode, then

$${C}_{+} > {C}_{-} and {ΔV}_{+} < Δ {V}_{-}$$

Therefore, manipulating the change in voltage of the first electrode (e.g., ΔV₊) to be less than the change in voltage of the second electrode (e.g., ΔV₋) can help minimize the overall change of voltage for the ultracapacitor (e.g., voltage retention rate).

Regardless, the thickness of the overall electrode (including the current collector and the carbonaceous coating(s) after optional compression) is typically within a range of from about 20 to about 350 micrometers. For instance, in some embodiments, the thickness of the overall electrode is about 30 micrometers or greater, such as about 40 micrometers or greater, such as about 50 micrometers or greater, such as about 75 micrometers or greater, such as about 100 micrometers or greater, such as about 125 micrometers or greater, such as about 150 micrometers or greater, such as about 200 micrometers or greater. In other embodiments, the thickness of the overall electrode is about 350 micrometers or less, such as about 325 micrometers or less, such as about 300 micrometers or less, such as about 275 micrometers or less, such as about 250 micrometers or less, such as about 225 micrometers or less, such as about 200 micrometers or less. In some embodiments, the thickness of the overall electrode is from about 30 to about 300 micrometers such as from about 50 to about 250 micrometers.

As indicated, the ultracapacitor also includes a separator. The separator is positioned between the first and second electrodes. If desired, other separators may also be employed in the ultracapacitor of the present invention. For example, one or more separators may be positioned over the first electrode, the second electrode, or both. The separators enable electrical isolation of one electrode from another to help prevent an electrical short, but still allow transport of ions between the two electrodes. The separators can also act as electrolyte reservoirs. In certain embodiments, for example, a separator may be employed that includes a cellulosic fibrous material (e.g., airlaid paper web, wet-laid paper web, etc.), nonwoven fibrous material (e.g., polyolefin nonwoven webs), woven fabrics, film (e.g., polyolefin film), etc. Cellulosic fibrous materials are particularly suitable for use in the ultracapacitor, such as those containing natural fibers, synthetic fibers, etc. Specific examples of suitable cellulosic fibers for use in the separator may include, for instance, hardwood pulp fibers, softwood pulp fibers, rayon fibers, regenerated cellulosic fibers, etc.

Regardless of the particular materials employed, the separator typically has a thickness of from about 5 to about 150 micrometers, in some embodiments from about 10 to about 100 micrometers, and in some embodiments, from about 20 to about 80 micrometers. Without intending to be limited by theory, the present inventors have found that the thicker the separator, the higher the voltage retention rate is for the ultracapacitor, meaning that it is less likely to “self-discharge.” For instance, a thicker separator allows for more ions in the separator, which are harder to deplete after the ultracapacitor has been completely charged. For instance, if the ions were to be depleted from the separator, the conductivity of the electrolyte would decrease, resulting in a high ion concentration gradient which is more likely to influence self-discharge behavior of the ultracapacitor. Whereas the thicker the separator, the more difficult it is to deplete the ions from the separator.

Additionally, the present inventors have found that the separator also serves as an electron insulator. For instance, the present inventors have also found that the resistance of the separator may also depend on the thickness and surface area of the separator. According to Ohm's law, which holds that current is equivalent to voltage/resistance (e.g., I=V/R), the ultracapacitor may have a lower leakage current, and therefore a lower self-discharge rate if the resistance of the ultracapacitor is higher.

As indicated, the ultracapacitor of the present invention employs a housing within which the electrodes, electrolyte, the separator, and the molecular sieve materials are retained and optionally hermetically sealed. Hermetic sealing is the process of creating an airtight container that prevents the leakage of gases, liquids, or solids. The housing may be slid over the ultracapacitor disclosed herein with multiple different forms of washers, collector discs, locknuts, flanges, lids, or combinations thereof. In some embodiments, the lid is drawn into the opening of the housing so that a rim of the lid sits inside a lip of the housing and is hermetically sealed via welding, adhesives, crimping or any other method known in in the art.

For instance, in some embodiments, to enhance the degree of hermetic sealing, the housing generally contains a metal container (“can”), such as those formed from tantalum, niobium, aluminum, nickel, hafnium, titanium, copper, silver, steel (e.g., stainless), alloys thereof, composites thereof (e.g., metal coated with electrically conductive oxide), and so forth. Aluminum is particularly suitable for use in the present invention. The metal container may have any of a variety of different shapes, such as cylindrical, D-shaped, etc. Cylindrically shaped containers are particularly suitable. In certain embodiments, when the housing is a metal container, the molecular sieve can be placed on the bottom or top of the can. The molecular sieve can also be placed on the side of the can.

In other embodiments, the housing may also comprise a flexible package. The flexible package generally includes a substrate that extends between two ends and that has edges. The ends and the sides of the package overlap and are fixedly and sealingly abutted against one another (e.g., by heat welding). In this manner, the electrolyte can be retained with the package. The substrate typically has a thickness within the range of from about 20 micrometers to about 1,000 micrometers, in some embodiments from about 50 micrometers to about 800 micrometers, and in some embodiments, from about 100 micrometers to about 600 micrometers.

The substrate of the flexible package may contain any number of layers desired to achieve the desired level of barrier properties, such as 1 or more, in some embodiments 2 or more, and in some embodiments, from 2 to 5 layers. Typically, the substrate contains a barrier layer, which may include a metal, such as aluminum, nickel, tantalum, titanium, stainless steel, etc. Such a barrier layer is generally impervious to the electrolyte so that it can inhibit leakage thereof, and also generally impervious to water and other contaminants. If desired, the substrate may also contain an outer layer that serves as a protective layer for the package. In this manner, the barrier layer is positioned between the outer layer and the electrode assembly. The outer layer may, for instance, be formed from a polymer film, such as those formed from a polyolefin (e.g., ethylene copolymers, propylene copolymers, propylene homopolymers, etc.), polyesters, etc. Particularly suitable polyester films may include, for example, nylon, polyethylene terephthalate, polyethylene naphthalate, polybutylene terephthalate, etc.

If desired, the substrate may also contain an inner layer that is positioned between the electrode assembly and the barrier layer. In certain embodiments, the inner layer may contain a heat-sealable polymer. Suitable heat-sealable polymers may include, for instance, polyethylene, polypropylene, vinyl chloride polymers, ionomers, etc., as well as combinations thereof. Ionomers are particularly suitable. In one embodiment, for instance, the ionomer may be a copolymer that contains an α-olefin and (meth)acrylic acid repeating unit. Specific α-olefins may include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Ethylene is particularly suitable. As noted, the copolymer may also be a (meth)acrylic acid repeating unit. As used herein, the term “(meth)acrylic” includes acrylic and methacrylic monomers, as well as salts or esters thereof, such as acrylate and methacrylate monomers. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. Typically, the α-olefin/(meth)acrylic acid copolymer is at least partially neutralized with a metal ion to form the ionomer. Suitable metal ions may include, for instance, alkali metals (e.g., lithium, sodium, potassium, etc.), alkaline earth metals (e.g., calcium, magnesium, etc.), transition metals (e.g., manganese, zinc, etc.), and so forth, as well as combinations thereof. The metal ions may be provided by an ionic compound, such as a metal formate, acetate, nitrate, carbonate, hydrogen carbonate, oxide, hydroxide, alkoxide, and so forth. In certain embodiments, when the housing is a flexible package, the molecular sieve material can be located on the top or bottom of the electrode/separator pack.

The manner in which the electrodes, the separator, the electrolyte and the molecular sieve material are inserted into the housing may vary as is known in the art. For example, the electrodes and separator may be initially folded, wound, or otherwise contacted together to form an electrode assembly. The electrolyte may optionally be immersed into the electrodes of the assembly. In one particular embodiment, the electrodes, separator, and optional electrolyte may be wound into an electrode assembly having a “jelly-roll” configuration.

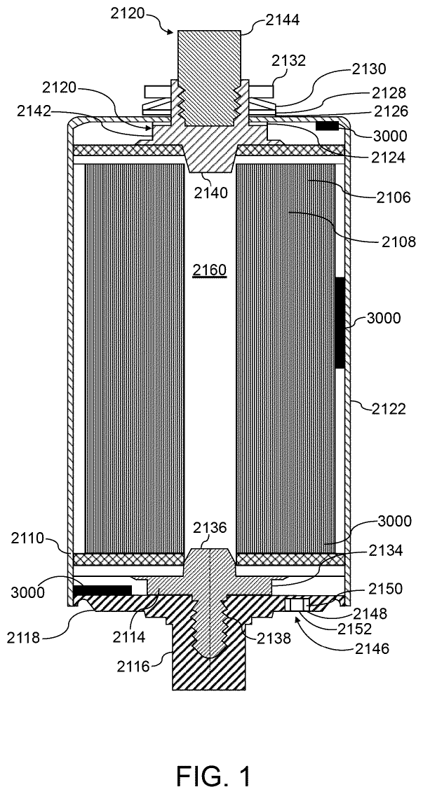

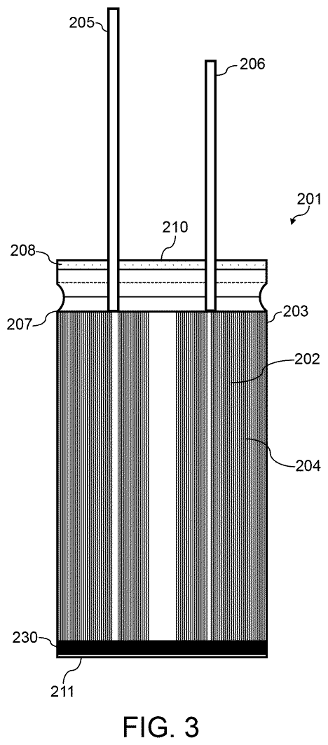

The electrode assembly may be sealed within the cylindrical housing using a variety of different techniques. The cylindrical housing may have a variety of configurations, including, but not limited to, those shown in FIG. 1 and FIG. 3. Referring to FIG. 1, one embodiment of an ultracapacitor is shown that contains an electrode assembly 2108, which contains layers 2106 wound together in a jellyroll configuration as discussed above. In this particular embodiment, the ultracapacitor contains a first collector disc 2114, which contains a disc-shaped portion 2134, a stud portion 2136, and a fastener 2138 (e.g., screw). The collector disc 2114 is aligned with a first end of a hollow core 2160, which is formed in the center of the electrode assembly, and the stud portion 2136 is then inserted into an opening of the core so that the disc-shaped portion 2134 sits against the first end of the electrode assembly 2108 at a first contact edge 2110. A lid 2118 is welded (e.g., laser welded) to a first terminal post 2116, and a socket, which may be for example, threaded, is coupled to the fastener 2138. The ultracapacitor also contains a second collector disc 2120, which contains a disc-shaped portion 2142, a stud portion 2140, and a second terminal post 2144. The second collector disc 2120 is aligned with the second end of the hollow core 2160, and the stud portion 2140 is then inserted into the opening of the core so that the collector disc portion 2142 sits against the second end of the electrode assembly 2108.

A metal container 2122 (e.g., cylindrically-shaped can) is thereafter slid over the electrode assembly 2108 so that the second collector disc 2120 enters the container 2122 first, passes through a first insulating washer 2124, passes through an axial hole at an end of the container 2122, and then passes through a second insulating washer 2126. The second collector disc 2120 also passes through a flat washer 2128 and a spring washer 2130. A locknut 2132 is tightened over the spring washer 2130, which compresses the spring washer 2130 against the flat washer 2128, which in turn is compressed against the second insulating washer 2126. The second insulating washer 2126 is compressed against the exterior periphery of the axial hole in the metal container 2122, and as the second collector disc 2120 is drawn by this compressive force toward the axial hole, the first insulating washer 2124 is compressed between the second collector disc 2120 and an interior periphery of the axial hole in the container 2122. A flange on the first insulating washer 2124 inhibits electrical contact between the second collector disc 2120 and a rim of the axial hole. Simultaneously, the lid 2118 is drawn into an opening of the container 2122 so that a rim of the lid 2118 sits just inside a lip of the opening of the container 2122. The rim of the lid 2118 is then welded to the lip of the opening of the container 2122.

Once the locknut 2132 is tightened against the spring washer 2130, a hermetic seal may be formed between the axial hole, the first insulating washer 2124, the second insulating washer 2126, and the second collector disc 2120. Similarly, the welding of the lid 2118 to the lip of the container 2122, and the welding of the lid 2118 to the first terminal post 2116, may form another hermetic seal. A hole 2146 in the lid 2118 can remain open to serve as a fill port for the electrolyte described above. Once the electrolyte is in the can (i.e., drawn into the can under vacuum, as described above), a bushing 2148 is inserted into the hole 2146 and seated against a flange 2150 at an interior edge of the hole 2146. The bushing 2148 may, for instance, be a hollow cylinder in shape, fashioned to receive a plug 2152. The plug 2152, which is cylindrical in shape, is pressed into a center of the bushing 2148, thereby compressing the bushing 2148 against an interior of the hole 2146 and forming a hermetic seal between the hole 2146, the bushing 2148, and the plug 2152. The plug 2152 and the bushing 2148 may be selected to dislodge when a prescribed level of pressure is reached within the ultracapacitor, thereby forming an overpressure safety mechanism.

As demonstrated by FIG. 1, the molecular sieve materials 3000 can be placed on the bottom or top of the aluminum can housing 2122 and can even be placed to sit sideways inside of the aluminum can 2122. It should be understood by one of ordinary skill in the art that the molecular sieve materials 3000 can be placed anywhere within the aluminum can housing 2122 and can have a circular “disc” shape, a rectangular shape, or any shape that may be known in the art.

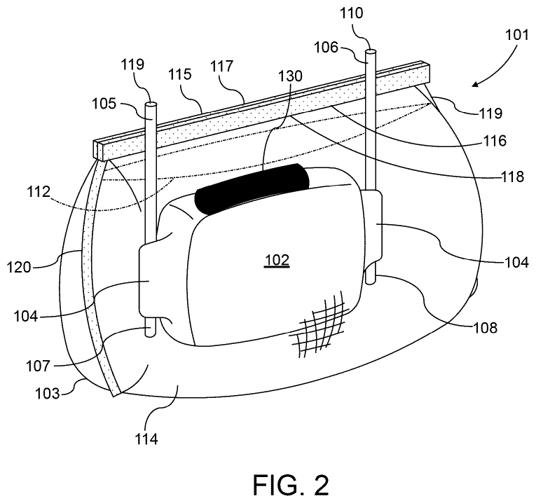

Referring now to FIG. 2, one embodiment of an ultracapacitor 101 is shown that contains a flexible package 103 that encloses an electrode assembly 102 and electrolyte 112. The electrode assembly 102 may contain electrodes 105 and 106 and a separator (not shown) stacked in a face to face configuration and connected together by opposing tabs 104. The ultracapacitor 101 also contains a first terminal 105 and a second terminal 106, which are respectively electrically connected with the tabs 104. More particularly, the electrodes 105 and 106 have first ends 107 and 108 disposed within the package 103 and respective second ends 109 and 110 disposed outside of the package 103. It should be understood that apart from stacking, the electrode assembly may be provided in any other form desired. For example, the electrodes may be folded or wounded together in a jelly roll configuration.

The package 103 generally includes a substrate 114 that extends between two ends 115 and 116 and that has edges 117, 118, 119 and 120. The ends 115 and 116, as well as the portions of both sides 119 and 120 that overlap, are fixedly and sealingly abutted against one another (e.g., by heat welding). In this manner, the electrolyte 112 can be retained within the package 103.

As shown in FIG. 2, the molecular sieve material 130 can be located on the top and/or bottom outside surface of the electrode assembly 102. It should be understood by one of ordinary skill in the art that the molecular sieve material 130 can have a circular “disc” shape, a rectangular shape, or any shape that may be known in the art.

Referring now to FIG. 3, one embodiment of an ultracapacitor 201 is shown that utilizes another variation of a cylindrical housing. For instance, a metal container 203 (e.g., a cylindrically-shaped can) contains the electrode assembly 202 which contains layers 204 wound together in a jellyroll configuration as discussed above. The metal container 203 can also retain the electrolyte. One end of the metal container 210 may include openings for the first terminal 205 and the second terminal 206, which are connected to the electrode assembly 202. A gasket 207 with holes configured to slide over the first terminal 205 and a second terminal 206 is inserted into the metal container 203. A sealing disk 208 with holes configured to slide over the first terminal 205 and second terminal 206 is then placed on top of the gasket 207. The gasket 207 and the sealing disk 208 may sealingly abut the first terminal 205 and second terminal 206.

As demonstrated by FIG. 3, the molecular sieve material 230 can be located on side 211 within the metal container 203. However, it should be understood by one of ordinary skill in the art that the molecular sieve material 230 can be placed anywhere within the metal container 203, such as on side 211, side 210, and can even be placed to sit sideways inside of the metal container 203. The molecular sieve material 230 can have a circular “disc” shape, a rectangular shape, or any shape that may be known in the art. Further, it should be understood to one of ordinary skill in the art that one or more molecular sieve materials may be employed within the metal container 203.

As discussed above, the resulting ultracapacitors with the molecular sieve materials may have improved electrochemical properties. For instance, ultracapacitors that were aged for 16 hours at 65° C. and at 2.7 V, fully discharged to 0 V for at least two hours to obtain an initial capacitance and ESR measurement according to IEC method, and then placed in an 85° C. oven and held at a voltage of 2.7 V for endurance testing demonstrated improved reliability in comparison to ultracapacitors subjected to the same endurance testing that lack a molecular sieve material.

In some embodiments, the resulting ultracapacitors with the molecular sieve material were able to retain greater than about 70% of the initial capacitance after multiple hours (e.g., 1000, 2000, 3000, 4000) of testing, such as greater than about 80% of the initial capacitance, such as greater than about 85% of the initial capacitance, such as greater than about 86% of the initial capacitance, such as greater than about 87% of the initial capacitance, such as greater than about 88% of the initial capacitance, such as greater than about 89% of the initial capacitance, and even greater than about 90% of the initial capacitance. In other embodiments, the resulting ultracapacitors with the molecular sieve material were able to retain about 10% or more of the initial capacitance compared to the ultracapacitor that did not contain a molecular sieve material, such as about 5% or more, such as about 4% or more, such as about 3% or more, such as about 2% or more, such as about 1% or more.

In other embodiments, the resulting ultracapacitors with the molecular sieve materials were able to have much lower increases in ESR gain in comparison to the ultracapacitors that did not have a molecular sieve material. For instance, the resulting ultracapacitors with the molecular sieve materials had about 400% or less of the initial ESR at 2500 hours, such as about 200% or less, such as about 150% or, such as 120% or less. In other embodiments, the resulting ultracapacitors with the molecular sieve materials were able to gain less than about 100% of the initial ESR in comparison to the ultracapacitors that did not have a molecular sieve material, such as less than about 50%, such as less than about 35%, such as less than about 30%, such as less than about 25%, such as less than about 20%.

The embodiments described above generally refer to the use of a single electrochemical cell in the capacitor. It should of course be understood, however, that the capacitor of the present invention may also contain two or more electrochemical cells. In one such embodiment, for example, the capacitor may include a stack of two or more electrochemical cells, which may be the same or different.

The present invention may be better understood with reference to the following example.

### Test Methods

### Equivalent Series Resistance (ESR)

Equivalence series resistance may be measured using a Hiller Instrument or Arbin Instrument by the IEC-62391 (2022) method. A variety of temperature levels may be tested. For example, the temperature may be 23° C., 65° C., 85° C. or 105° C., and the relative humidity may be 25% or 85%.

### Capacitance

The capacitance may be measured using a Hiller Instrument or Arbin Instrument by the IEC-62391 (2022) method. A variety of temperature levels may be tested. For example, the temperature may be 23° C., 65° C., 85° C. or 105° C., and the relative humidity may be 25% or 85%.

### Ionic Radius Size

The ionic radius is the effective distance between the nucleus's center and the electronic cloud where the ion exerts its influence. The ionic radius size may be measured using Pauling's method. Pauling's method holds that in an ionic crystal type of M⁺X⁻, cations and counterions are in contact with each other. Therefore, the sum of their ionic radius is equal to the interionic distance. Therefore, we can determine the value of the cationic radius or the counterion radius:

$${r}_{M}^{+} + {r}_{X}^{-} = ( c / ( {Z}_{eff} ( {M}^{+} ) ) + ( c / {Z}_{eff} ( {X}^{-} ) ) ( p m )$$

wherein Z_{eff} is the effective nuclear charge. Z_{eff}=Z−σ; where σ is the screening constant.
Therefore, the ionic radius of the cationic species is;

$${r}_{M}^{+} = ( c / ( {Z}_{eff} ( {M}^{+} ) )$$

and the ionic radius of the counterion is:

$${r}_{X}^{-} = ( c / {Z}_{eff} ( {X}^{-} ) )$$

### Voltage Retention Rate

The voltage retention rate (e.g. “self-discharge” rate) of a single ultracapacitor may be measured by aging the ultracapacitor for 16 hours at 65° C. and 2.7 volts before fully discharging to 0 volts at less two hours. The ultracapacitors were first charged to 2.5 volts using a constant current of 0.25 A, and held at 2.5 volts until the charging current was 10 mA. Once the charging current was 10 mA, the power source was turned off and the cell voltage was monitored for 16 hours. The difference in initial voltage when the power source was turned off to the final voltage tested after 16 hours is then calculated as the ultracapacitor's voltage retention rate. For instance:

$$Voltage Retention Rate \% = Δ V = ( {V}_{f} / {V}_{i} ) \times 100$$

Wherein V_{f} is the final voltage tested after 16 hours and Vᵢ is the initial voltage.

### Voltage Retention Rate Ratio

The voltage retention rate ratio between at least two ultracapacitors is calculated by dividing the voltage retention rate of each ultracapacitor. For example, if there are two ultracapacitors in a module:

$$Voltage Retention Rate \% of Ultracapacitor 1 = Δ {V}_{1} = ( {V}_{f 1} / {V}_{i 1} ) \times 100$$

$$and$$

$$Voltage Retention Rate \% of Ultracapacitor 2 = Δ {V}_{2} = ( {V}_{f 2} / {V}_{i 2} ) \times 100$$

$$and$$

$$Voltage Retention Rate Ratio = Δ {V}_{1} / Δ {V}_{2}$$

### Example 1

The ability to form an electrochemical cell in accordance with the present invention was demonstrated. Initially, each side of two aluminum current collectors (thickness of 12 to 50 μm) containing aluminum carbide whiskers or etched aluminum foils were coated with a mixture of 70-95 wt. % of activated carbon particles, 2-10 wt. % of a styrene-butadiene copolymer, and 1-4 wt. % of sodium carboxymethylcellulose. The thickness of each resulting coating was 200 μm. The electrodes were then calendared and dried under vacuum at a temperature of from 70° C. to 200° C. Once dried, the electrodes were slitted to the desired size. Once formed, the two electrodes were assembled with an electrolyte and a separator (cellulose material having a thickness of 25 μm or 30 μm) and wound to form “jelly rolls” according to the designed diameter size. The jelly rolls were then completely dried confirming by the Karl-Fischer titration method. After the jelly rolls were dried, an electrolyte containing spiro-(1,1′)-bipyrrolidinium tetrafluoroborate at a concentration of 1.0 M in acetonitrile was prepared. The jellyrolls were saturated with the electrolyte. A portion of the jellyrolls were inserted with a rubber gasket into an aluminum can, and the aluminum can did not receive a molecular sieve material. A second portion of the jellyrolls were assembled in the same manner, except one piece of 3 angstrom molecular sieve film disc (100 μm) was placed at the bottom of the aluminum can before the jellyroll and the gasket were inserted. The aluminum can was crimped for cell sealing.

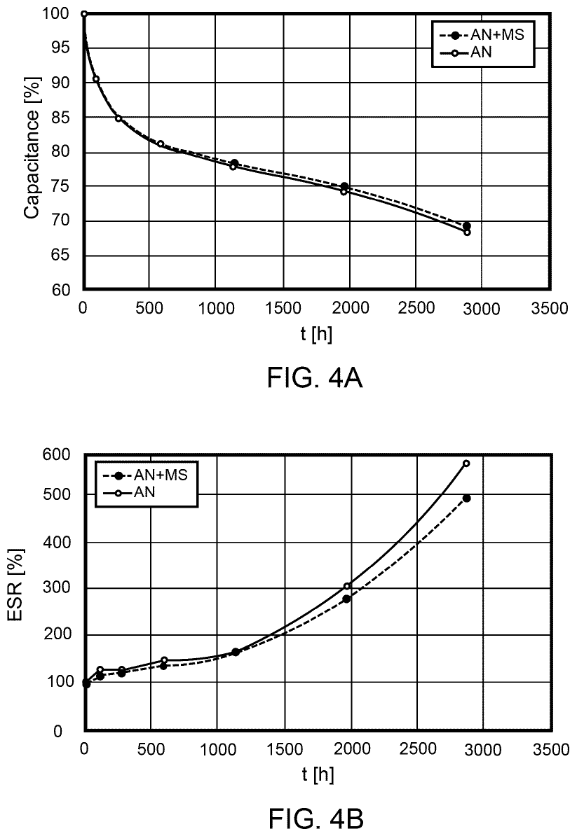

The ultracapacitors then aged for 16 hours at 65° C. and at 2.7 V. The ultracapacitors were then fully discharged to 0 V for at least two hours to obtain an initial capacitance and ESR measurement according to IEC method. The ultracapacitors were then placed in an 85° C. oven and held at a voltage of 2.7 V for endurance testing. After a predetermined period of time, the ultracapacitors were removed from the oven and cooled down to room temperature. Once the ultracapacitors had cooled, measurements of their capacitance and ESR after discharging them to 0 V for at least 2 hours were obtained. The results are set forth in FIG. 4A and FIG. 4B.

As demonstrated by FIG. 4A, the ultracapacitors with a molecular sieve material had a higher percentage of capacitance retention. Further, as demonstrated by FIG. 4B, the ultracapacitors with a molecular sieve material unexpectedly had a lower percentage of ESR gain, indicating that the ultracapacitors that had a molecular sieve material had lower levels of ESR gain, even after endurance testing, than the capacitors that did not include a molecular sieve material.

### Example 2

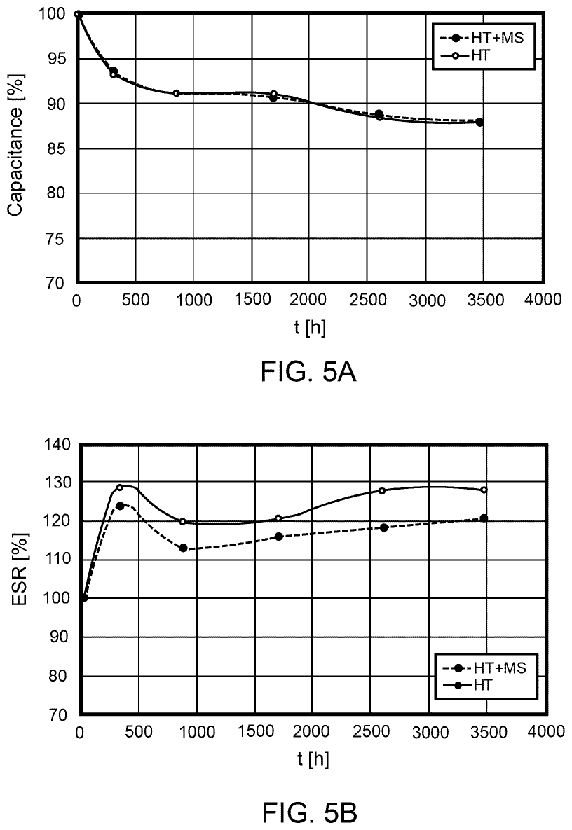

The jelly roll configurations of electrodes and separators were prepared, assembled, and dried in the same manner as described in Example 1, except that the electrolyte contained spiro-(1,1′)-bipyrrolidinium tetrafluoroborate at a concentration of 2.0 M in sulfolane/dimethyl sulfone. Like Example 1, a portion of the aluminum cans did not have a molecular sieve material and a portion of the aluminum cans had one piece of 3 angstrom molecular sieve film disc (100 μm) placed at the bottom of the aluminum can. The evaluation method of the ultracapacitors was the same as described in Example 1. The results are set forth in FIG. 5A and FIG. 5B.

As demonstrated by FIG. 5A and FIG. 5B, not all electrolytes have the same effect on capacitance and ESR when a molecular sieve material is used. For instance, while no significant change in capacitance retention was demonstrated between ultracapacitors with a molecular sieve material and that did not have a molecular sieve material, the ultracapacitors with a molecular sieve material had a lower percentage of ESR gain than the capacitors that did not include a molecular sieve material, even after endurance testing.

### Example 3

The electrodes were prepared the same as in Examples 1 and 2, except that the electrodes were cut into pieces with the dimensions of 31 mm×35 mm with a tab.

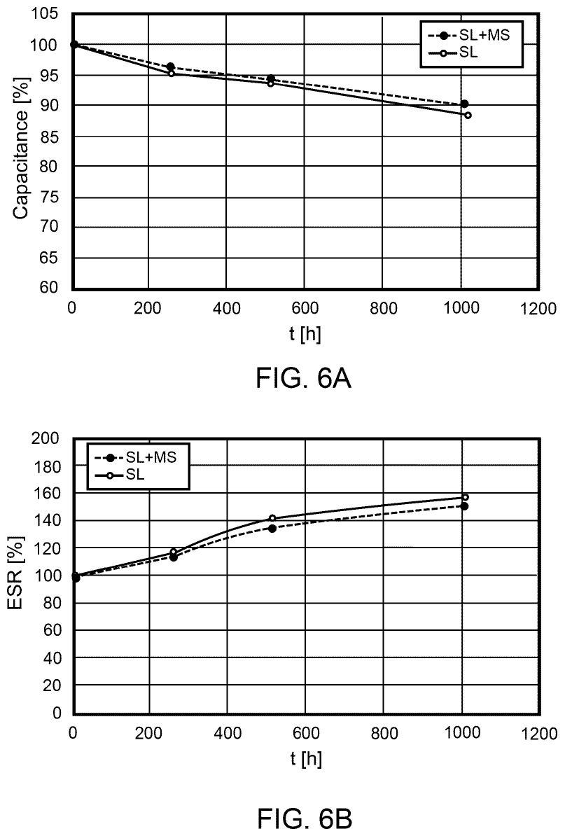

Pouch cells including 4 negative electrodes and 3 positive electrodes, for a total of 7 electrodes, were assembled and filled with an electrolyte containing spiro-(1,1′)-bipyrrolidinium tetrafluoroborate at a concentration of 2.0 M in sulfolane/dimethyl sulfone. Like Examples 1 and 2, a portion of the pouch cells did not have a molecular sieve material and a portion of the pouch cells included one piece of 3 angstrom molecular sieve film (30 mm×40 mm) either at the top or the bottom of the electrode pack. The capacity of the ultracapacitors is 20 F. The evaluation method of the ultracapacitors was the same as described in Example 1, except that the endurance test was at 3.0 V and at 65° C. The results are set forth in FIG. 6A and FIG. 6B.

As demonstrated by FIG. 6A and FIG. 6B, the presence of a molecular sieve material provides advantages to the ultracapacitor, even when the ultracapacitor is retained within a pouch cell. As demonstrated by FIG. 6A, the ultracapacitors with a molecular sieve material had a higher percentage of capacitance retention. Further, as demonstrated by FIG. 6B, the ultracapacitors with a molecular sieve material had a lower percentage of ESR gain.

Thus, Examples 1-3 demonstrate that the molecular sieve material as disclosed herein may result in more reliable energy ultracapacitors with better electrochemical properties, as the presence of only one molecular sieve material can improve the capacitance retention and decrease the ESR gain of the ultracapacitors over time and at harsh environments.

These and other modifications and variations of the present invention may be practiced by those of ordinary skill in the art, without departing from the spirit and scope of the present invention. In addition, it should be understood that aspects of the various embodiments may be interchanged both in whole and in part. Furthermore, those of ordinary skill in the art will appreciate that the foregoing description is by way of example only and is not intended to limit the invention so further described in such appended claims.

What is claimed is:

1. An ultracapacitor comprising:
a first electrode that comprises a first current collector electrically coupled to a first carbonaceous coating;
a second electrode that comprises a second current collector electrically coupled to a second carbonaceous coating;
a separator positioned between the first electrode and the second electrode;
a nonaqueous electrolyte in ionic contact with the first electrode and the second electrode;
a molecular sieve material comprising a metal aluminosilicate and a binder; and
a housing within which the first electrode, the second electrode, the separator, the nonaqueous electrolyte, and the molecular sieve material are retained.

2. The ultracapacitor of claim 1, wherein the molecular sieve material has an average pore size of about 3 angstroms to about 10 angstroms.

3. The ultracapacitor of claim 1, wherein the molecular sieve material has an average pore size of about 3 angstroms to about 4 angstroms.

4. The ultracapacitor of claim 1, wherein the metal aluminosilicate has a chemical formal of ⅔K₂O1₃·Na₂₂O·Al₂O₃·2SiO₂·4.5H₂O.

5. The ultracapacitor of claim 1, wherein the metal aluminosilicate has a chemical formula of Na₂O·Al₂O₃·2SiO₂·4.5H₂O.

6. The ultracapacitor of claim 1, wherein the binder comprises a polytetrafluoroethylene, a polyethylene, a polypropylene, a styrene-butadiene copolymer or a combination thereof.

7. The ultracapacitor of claim 1, wherein the binder is present in the molecular sieve material from about 5 wt. % to about 20 wt. %.

8. The ultracapacitor of claim 1, wherein the molecular sieve material has a circular shape or a rectangular shape.

9. The ultracapacitor of claim 1, wherein the molecular sieve material is placed on a top of the housing, a bottom of the housing, a side of the housing, or a combination thereof.

10. The ultracapacitor of claim 1, wherein the molecular sieve material is not placed on a surface of the first electrode or the second electrode.

11. The ultracapacitor of claim 1, wherein the first current collector, the second current collector, or both contain a substrate that includes a conductive metal.

12. The ultracapacitor of claim 11, wherein the conductive metal is aluminum or an alloy thereof.

13. The ultracapacitor of claim 1, wherein the first carbonaceous coating, the second carbonaceous coating, or both have a thickness of about 200 micrometers or less.

14. The ultracapacitor of claim 1, wherein the first electrode, the second electrode, or both have a thickness of from about 20 micrometers to about 350 micrometers.

15. The ultracapacitor of claim 1, wherein the separator includes a cellulosic fibrous material.

16. The ultracapacitor of claim 1, wherein the housing comprises a metal container.

17. The ultracapacitor of claim 1, wherein the housing comprises a flexible package.

18. The ultracapacitor of claim 1, wherein the first electrode, the second electrode, the nonaqueous electrolyte, the separator, and the molecular sieve material are hermetically sealed within the housing.

19. A method for producing a molecular sieve material for use in an ultracapacitor comprising:
grinding pellets comprising a metal aluminosilicate to form a ground metal aluminosilicate;
mixing the ground metal aluminosilicate with a binder to form a mixture; and
extruding the mixture through a die at a temperature of from about 100° C. to about 200° C. to form the molecular sieve material.

20. The method of claim 19, further comprising manipulating the molecular sieve material to have a circular shape or a rectangular shape.

21. The method of claim 19, wherein the metal aluminosilicate has a chemical formal of ⅔K₂O1₃·Na₂₂O·Al₂O₃·2SiO₂·4.5H₂O.

22. The method of claim 19, wherein the metal aluminosilicate has a chemical formula of Na₂O·Al₂O₃·2SiO₂·4.5H₂O.

23. The method of claim 19, wherein the binder comprises a polytetrafluoroethylene, a polyethylene, a polypropylene, a styrene-butadiene copolymer, or a combination thereof.

24. The method of claim 19, wherein the mixture comprises about 5 wt. % to about 20 wt. % of the binder.

25. The method of claim 19, wherein the molecular sieve material has an average pore size of about 3 angstroms to about 10 angstroms.

26. The method of claim 19, wherein the molecular sieve material has an average pore size of about 3 angstroms to about 4 angstroms.
